(19) United States
(12) Patent Application Publication
(10) Pub. No.: US 2015/0241036 A1
(43) Pub. Date: Aug. 27, 2015

(54) SUPPORTING DEVICE FOR LEDS, PARTICULARLY FOR LED MODULES

(71) Applicant: A.A.G. STUCCHI S.R.L., Olginate (IT)

(72) Inventor: Antonietta STUCCHI, Olginate (IT)

(73) Assignee: A.A.G. STUCCHI S.R.L., Olginate (IT)

(21) Appl. No.: 14/618,203

(22) Filed: Feb. 10, 2015

(30) Foreign Application Priority Data
Feb. 21, 2014 (IT) MI2014A000255

(51) Int. Cl. F21V 21/03; F21K 99/00; F21V 21/08; F21V 19/00; F21V 21/088

(52) U.S. Cl. CPC F21V 21/03; F21V 19/003; F21V 21/088; F21V 21/0832; F21K 9/30; F21Y 2101/02

(57) ABSTRACT

A supporting device for LEDs, particularly for LED modules, comprising a device body provided with at least one seat for accommodating an LED module, and with a base for the installation of the body on a ceiling fixture.

The present invention relates to a supporting device for LEDs, particularly for LED modules. More specifically, the invention relates to a supporting device for LEDs which can be used advantageously for supporting conventional LED modules.

The current market offers many solutions for LED modules which are made by soldering the individual LEDs onto electronic cards of various shapes, square, rectangular etc. Usually low-power LEDs are used, which make it possible to obtain “self-dissipating” modules, i.e. modules that do not need to be mounted on a heat sink.

Such modules are particularly adapted for applications where diffused light is needed, for example in most applications where to date linear fluorescent lamps have been used.

The modules are usually fixed directly to the ceiling fixture by way of screws. Such modules are usually powered by low-voltage direct current and have two contacts (positive and negative) that are adapted to allow the soldering of the wires that come from the power supply.

In order to avoid soldering the wires it is possible to mount terminals that allow wires to be rapidly inserted.

The presence of the above mentioned terminals makes it possible to automatically wire the ceiling fixture, using for example the same robots that currently wire fluorescent ceiling fixtures.

The solutions proposed above suffer however a number of problems.

Firstly, mechanical fixing by way of screws is not very efficient in that it requires that there are several holes in the ceiling fixture, as well as long periods of time, whether it is executed manually or by way of an automatic mounting robot.

Furthermore, soldering is a slow and critical process and, as noted, it is avoided by using rapid-connecting terminals which however are installed on the LED modules proper. Thus the wiring process, both automatic and manual, can occur only after having installed the LED modules.

In traditional ceiling fixtures, the wiring of the ceiling fixtures (which are fitted with lamp holders) was executed without the lamps being mounted. This made it possible to manage the production, mounting and wiring of the apparatuses without the presence of the component discussed here, i.e. the light source.

Furthermore, the apparatus could be stored without lamps, which were installed just before being packaged, thus reducing stock levels and achieving great flexibility in terms of the type of lamp required by the customer. In some cases the apparatus was sold directly without the lamps.

Current LED boards do not allow all this, thus creating considerable drawbacks of management in the production and storage of ceiling fixtures and greatly limiting the flexibility of configuration of the finished product. The problem is particularly aggravated by the fact that the new LED sources are much more delicate than traditional lamps and much costlier.

Furthermore, substitution for maintenance purposes of a module that is fixed by way of screws is a complex operation and not intended for users with no training.

The aim of the present invention is to provide a supporting device for LEDs, particularly for LED modules, which makes it possible use a LED ceiling fixture with the same simplicity and flexibility as ceiling fixtures with traditional lamps.

Within this aim, an object of the present invention is to provide a supporting device for LEDs, particularly for LED modules, which can be installed in fluorescent ceiling fixtures, without making any modification to them.

Another object of the present invention is to provide a supporting device for LEDs, particularly for LED modules, which can be used with a wide range of types of LED modules.

Another object of the present invention is to provide a supporting device for LEDs which makes the substitution and maintenance of the LED module that it supports particularly simple and rapid.

Another object of the present invention is to provide a supporting device for LEDs that is highly reliable, easily and practically implemented and low cost.

This aim and these and other objects which will become better apparent hereinafter are achieved by a supporting device for LEDs, particularly for LED modules, characterized in that it comprises a device body provided with at least one seat for accommodating an LED module and with a base for the installation of said body on a ceiling fixture.

Further characteristics and advantages of the invention will become better apparent from the description of preferred, but not exclusive, embodiments of the supporting device for LEDs according to the invention, illustrated by way of non-limiting example in the accompanying drawings wherein:

FIG. 1 is a perspective view of the supporting device according to the invention and an LED module that is adapted to be accommodated in the device;

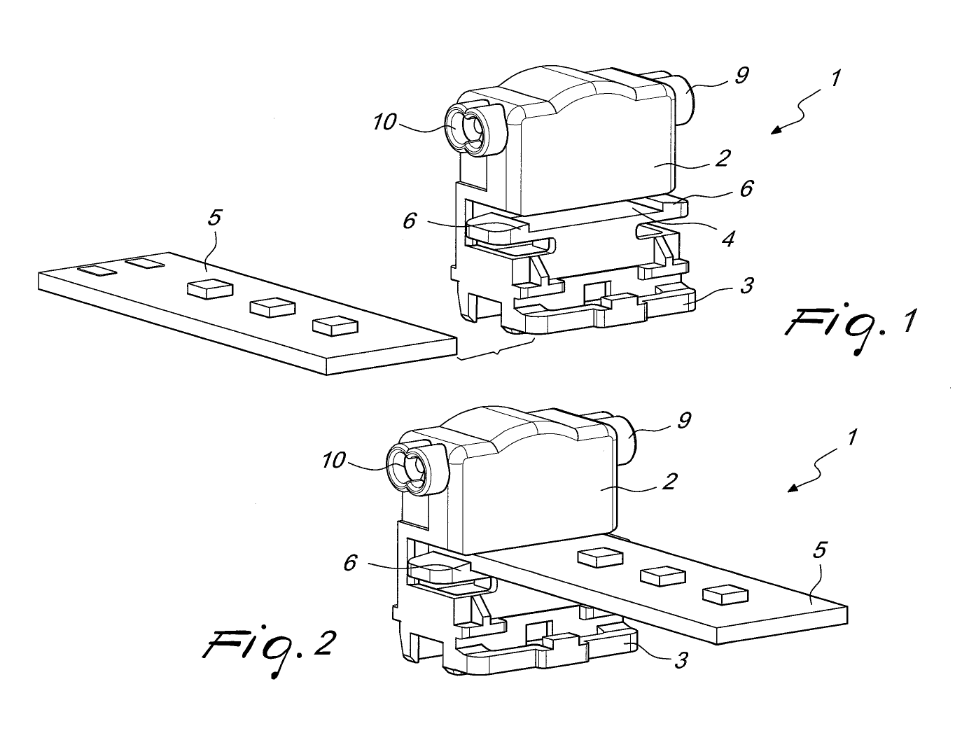

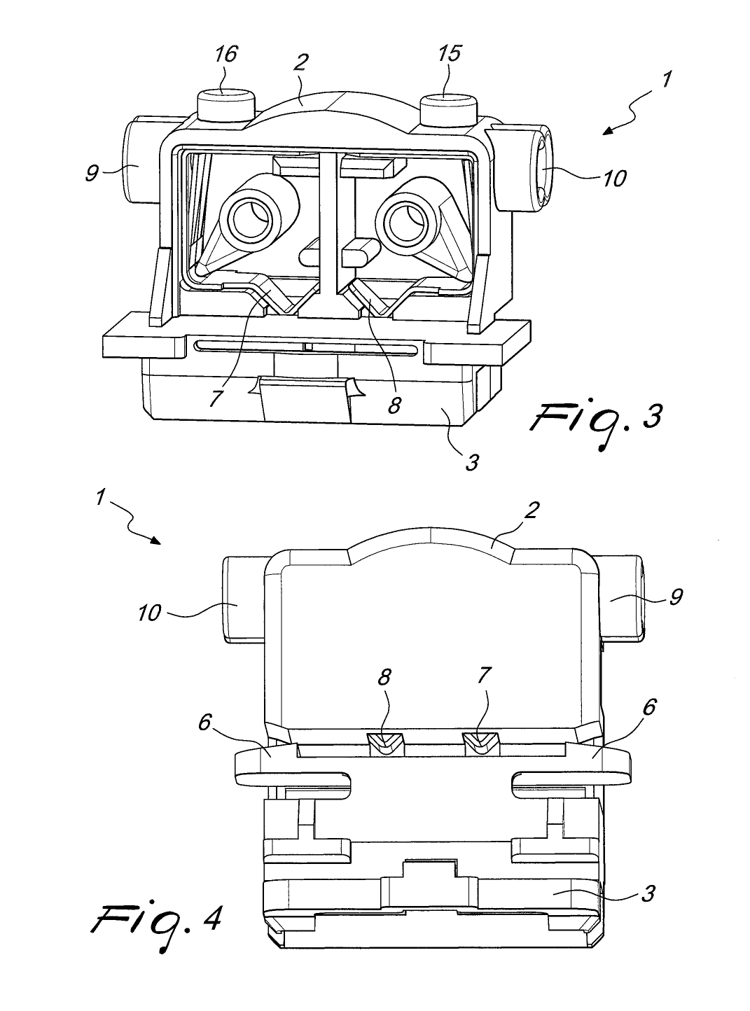

FIG. 2 is a perspective view of the supporting device according to the invention with the LED module accommodated in it, according to a first embodiment;

FIG. 3 is a perspective view of a second embodiment of the supporting device according to the invention;

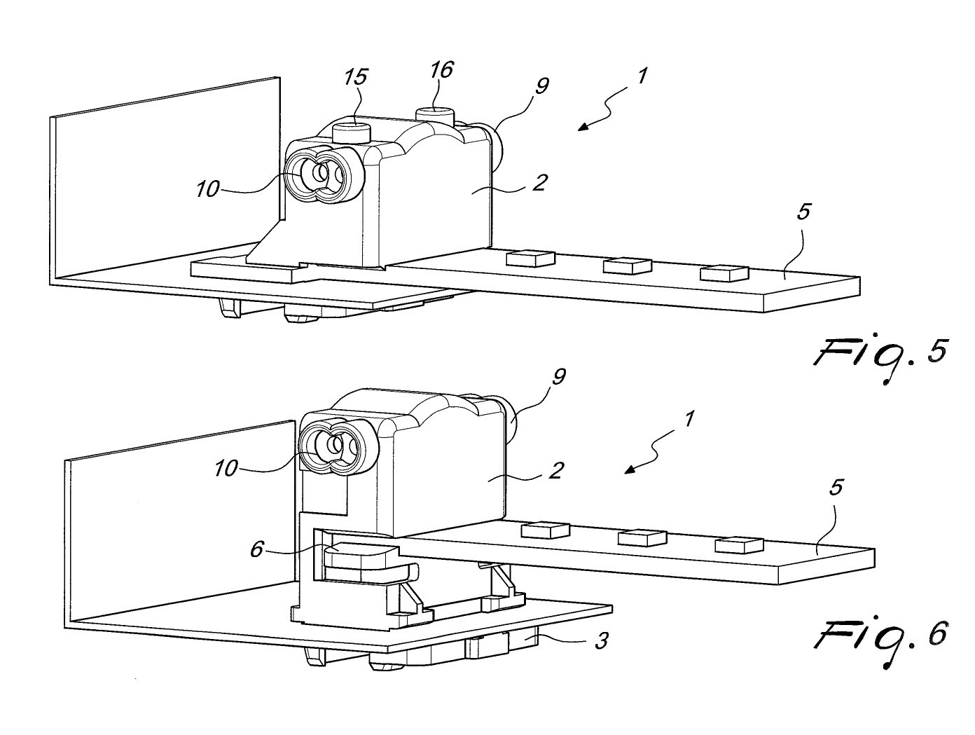

FIG. 4 is a rear elevation view of the supporting device shown in FIG. 1;

FIG. 5 shows the method of installation of the supporting device according to the second embodiment;

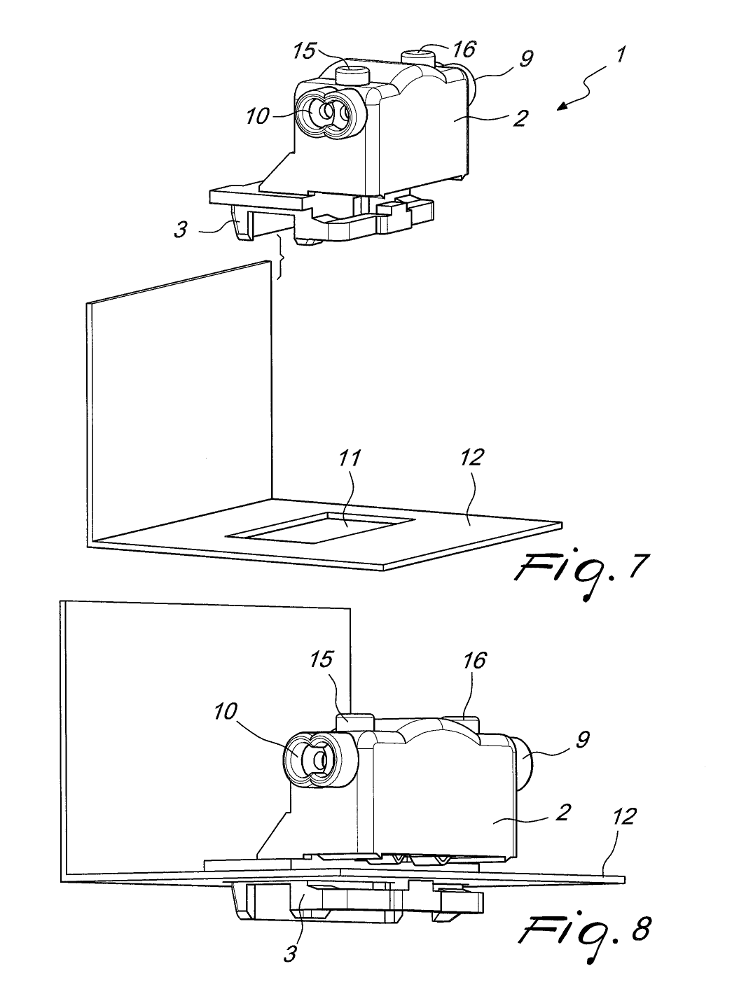

FIG. 6 shows the method of installation of the supporting device according to the first embodiment;

FIG. 7 is an exploded perspective view of the method of installation of FIG. 5;

FIG. 8 is a perspective view of the installed supporting device, according to the method in FIG. 7;

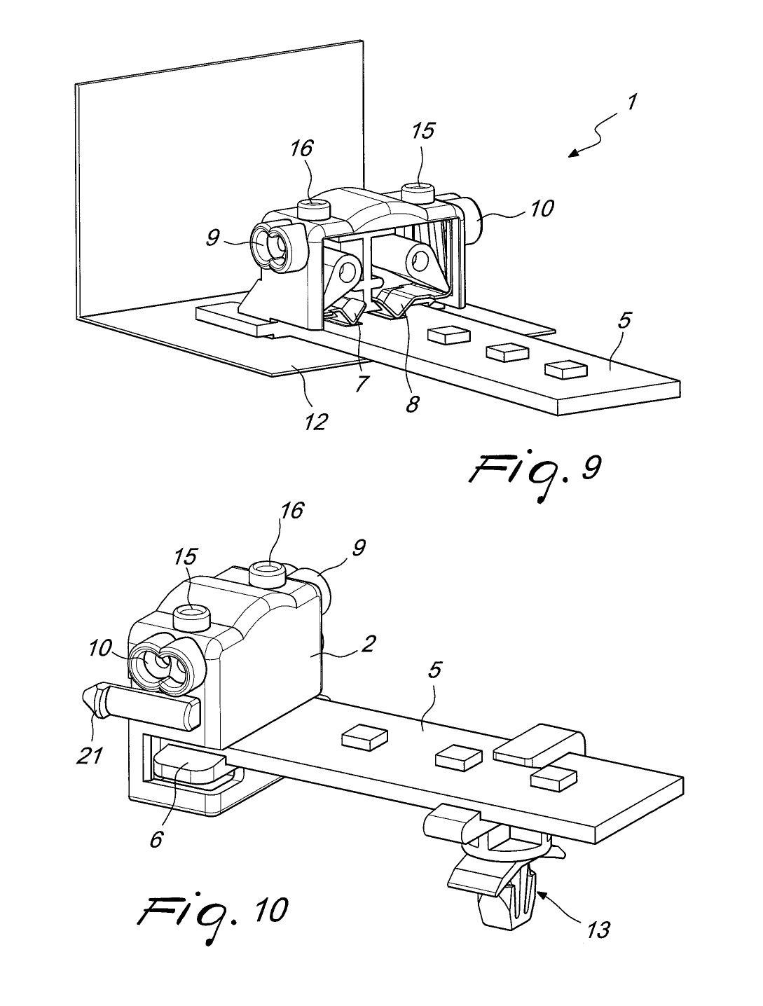

FIG. 9 is a cutaway perspective view of the installation in FIGS. 7 and 8;

FIG. 10 is a perspective view of an accessory for mounting the device according to the invention;

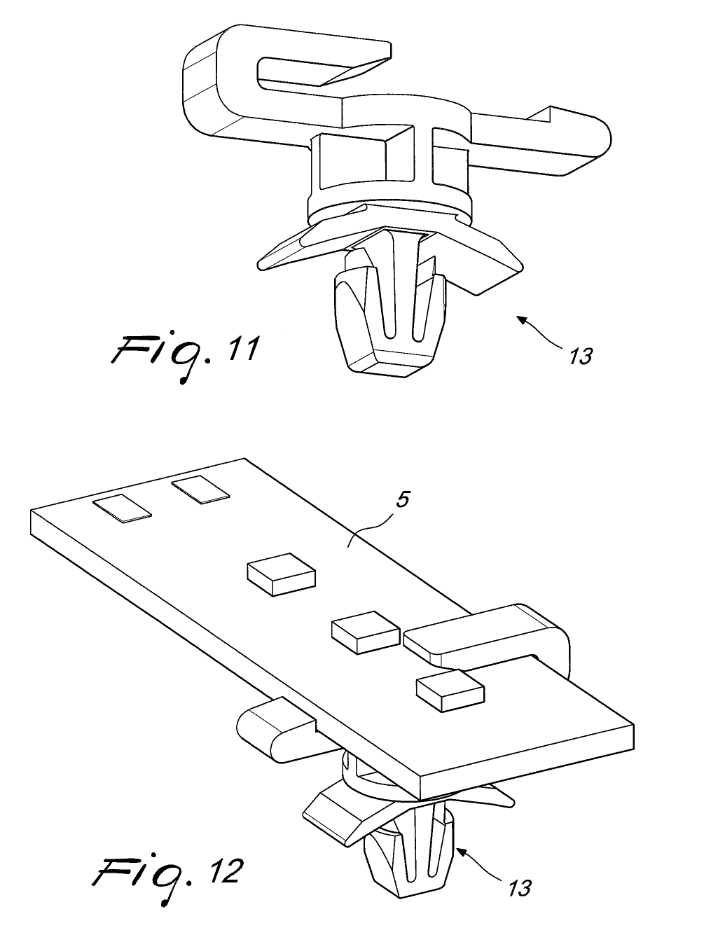

FIG. 12 is a perspective view of the coupling of the accessory in FIG. 11 to an LED module;

FIG. 11 is a perspective view of the accessory in FIG. 10;

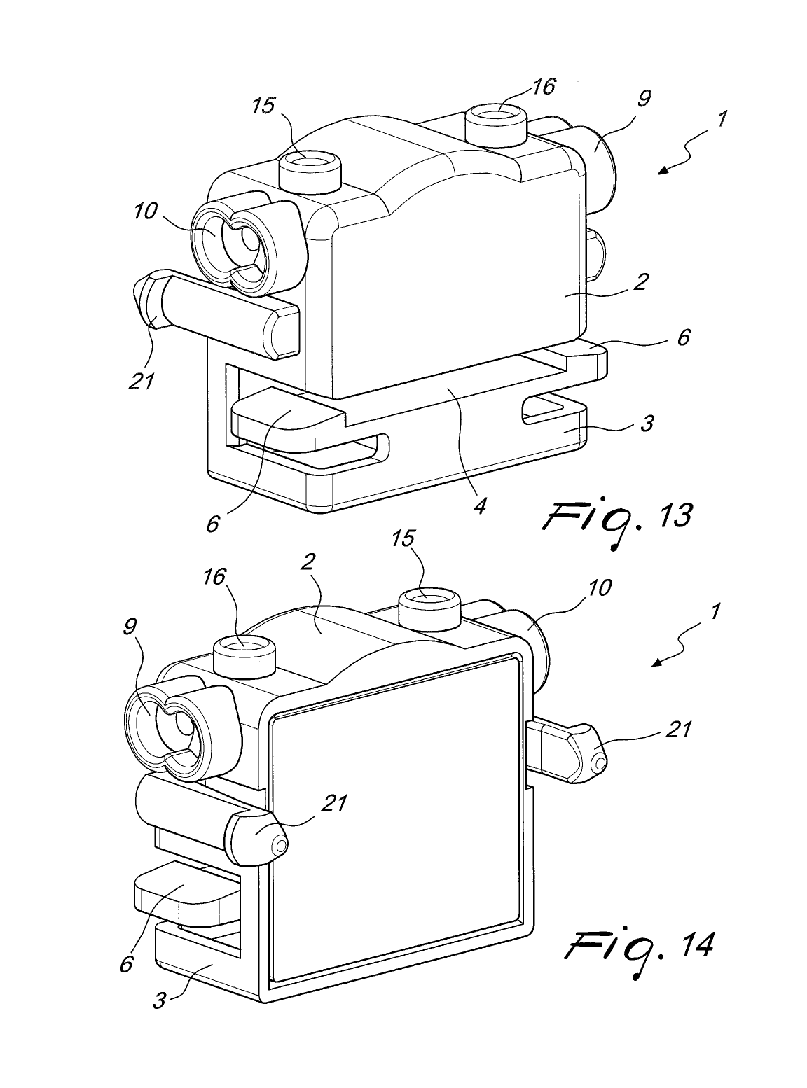

FIG. 13 is a perspective view from the front of the supporting device according to the invention, with a variation of embodiment, previously shown in other figures;

FIG. 14 is a perspective view from the rear of the supporting device according to the invention, with a variation of embodiment, previously shown in other figures;

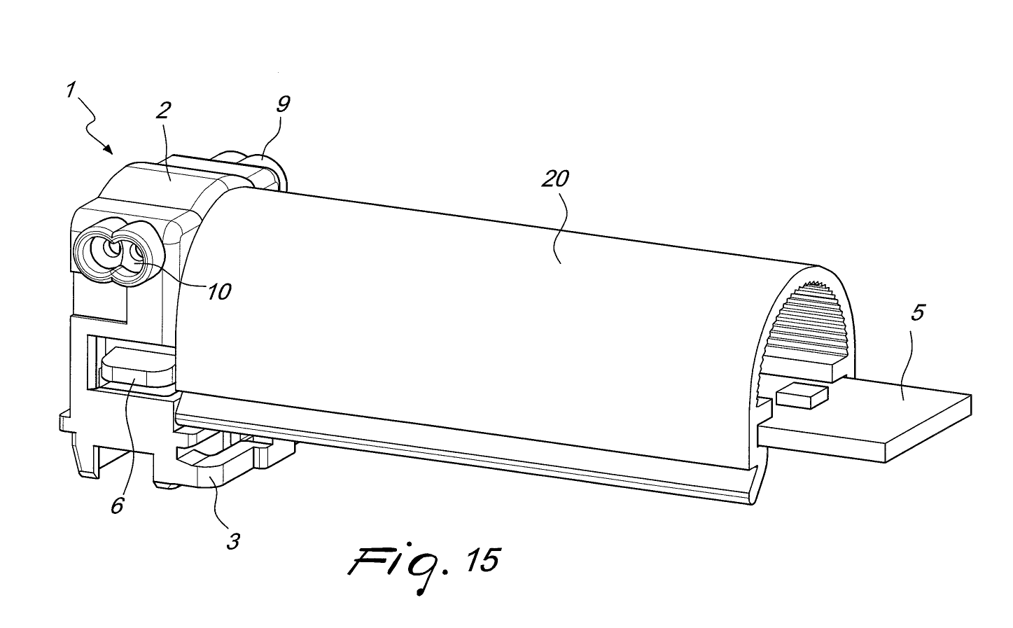

FIG. 15 is a perspective view of a LED lamp installed by way of using the supporting device according to the invention.

With reference to the figures, the supporting device for LEDs according to the invention, generally designated by the reference numeral 1, comprises a body 2 provided with a base 3 that is adapted to allow the installation of the device in a ceiling fixture 12, similarly to what would happen with a fluorescent lamp holder device which is usually used in the ceiling fixture.

The body 2 is further provided with at least one seat 4 adapted to allow the insertion and locking of an LED module 5.

Conveniently, at least one seat 4 is defined so that once the body 2 is installed on the ceiling fixture, the LED module 5 that is inserted in the seat 4 is arranged in the correct position in the ceiling fixture 12. Conveniently, the seat 4 is provided with a pair of flexible hooks 6, which are adapted to mechanically retain the LED module 5 once this is inserted in the seat 4.

Advantageously, the body 2 is further provided with electrical contacts 7 and 8 which are arranged so as to protrude, facing toward the seat 4 in which the LED module 5 is accommodated. The electrical contacts 7 and 8, which are conveniently constituted by metallic plates, are connected with corresponding holes 9 and 10 which are adapted to accommodate the wires originating from power supply means.

The insertion of the LED module 5 into the seat 4 occurs laterally (“edge-on”) by way of the presence of the flexible hooks 6 mentioned previously.

Therefore, the supporting device for LEDs according to the invention has the twofold function of mechanical retention and of electrical connection of the LED module 5.

The supporting device for LEDs can be constituted so as to have the LED module 5 in contact with the ceiling fixture, or, in an alternative embodiment, the body 2 of the supporting device 1 can have a different height with respect to the body used if the LED module must not be in contact with the ceiling fixture 12, so that the LED module 5 is not in contact with the ceiling fixture but is distanced from it.

The base 3 of the supporting device according to the invention makes it possible for it to be accommodated in the same holes 11 that are intended for a traditional lamp holder, and which are present in ceiling fixtures 12.

Conveniently, if the LED module 5 is not sufficiently rigid, owing for example to its length, it is possible to have some clips 13 that are adapted to be coupled to the LED module 5, and to stably retain the module even if it is not in contact with the surface of the ceiling fixture 12.

Furthermore, the body 2 of the supporting device according to the invention can be provided with a pair of holes 15, 16, which are arranged in an upper position, in order to allow access to the contacts 7 and 8 that were described previously, in order to execute a test during the wiring step, in order to verify that the wiring is good.

The supporting device according to the invention makes it possible to provide a genuine LED lamp without having to develop a dedicated lamp mount. In fact, by providing an extruded element made of transparent plastic material, 20, plus an optional aluminum base, it is possible to provide an LED lamp.

The extruded element 20 is for example conveniently shaped like a cover so as to cover the LED module 5.

Operation of the supporting device for LEDs according to the invention is as follows.

Firstly, the supporting device 1 is fixed to the ceiling fixture and subsequently the LED module 5 is inserted, laterally, in the seat 4 defined in the body 2 of the device according to the invention.

The presence of the elements or flexible hooks 6 makes it possible to insert the LED module 5 in the seat 4 and to retain it mechanically in such seat.

Once inserted in the seat 4, the LED module 5 comes into contact with the electrical contacts 7 and 8 that protrude into such seat.

At this point the wires for the power supply are inserted in the holes 9 and 10 for the wires of the supporting device according to the invention.

It should be noted that the supporting device 1 is installed in its seat defined in the ceiling fixture, similarly to what would happen with an LED module, which happens by fixing a screw directly to the ceiling fixture.

In this case, however, screwing the LED module is no longer necessary, to the great advantage of the installation.

Furthermore, it is not necessary to solder the wires as was previously necessary.

If the supporting device is of the type shown in FIG. 5, then the LED module 5 is mechanically retained between the supporting device 1 and the base of the ceiling fixture. If the supporting device is of the type shown in FIG. 6, then the LED module 5 is mechanically retained between the body 2 and the seat 4 of the device proper. The electrical contacts 7 and 8 of the body 2 of the supporting device according to the invention are aligned and ensure the electrical connection of the LED module/body of the supporting device thanks to a suitable pressure exerted by the metallic parts of the supporting device on the pads of the card of the LED module 5.

Conveniently, the body 2 of the supporting device according to the invention can be provided for wall mounting, not in contact with the ceiling fixture, and in this case the body is provided with a pair of pins 21 so as to be able to execute the wall fixing.

In practice it has been found that the supporting device according to the present invention fully achieves the set aim and objects, in that it makes it possible to not damage the LED card during the process of production and storage of the apparatus. Furthermore, the apparatus can be wired by way of current automatic wiring machines without any difficulty and the LED module can be installed without the use of any tool.

Even further, the maker has great flexibility in the choice of the type of module to install according to customer requirements, at the end of the production process or after the wiring.

Furthermore, the mechanical fixing of the module is performed without the use of screws, thus without making holes in the supporting card.

Furthermore, the electrical soldering of LED modules is avoided, and substitution of the LED module is extremely simple in that it is sufficient to uncouple it from the seat of the supporting device according to the invention.

Furthermore, the supporting device according to the invention makes it possible to use the same structure as current ceiling fixtures for fluorescent lamps without modifying them, simply by installing LED supporting devices that are adapted to the chosen card, in place of the lamp holder for fluorescent lamps.

The device, thus conceived, is susceptible of numerous modifications and variations, all of which are within the scope of the appended claims. Moreover, all the details may be substituted by other, technically equivalent elements.

In practice the materials employed, and the contingent dimensions and shapes, may be any according to requirements and to the state of the art.

The disclosures in Italian Patent Application No. MI2014A000255 from which this application claims priority are incorporated herein by reference.

What is claimed is:

1. A supporting device for LEDs, particularly for LED modules, comprising a device body provided with at least one seat for accommodating an LED module and with a base for the installation of said body on a ceiling fixture.

2. The device according to claim 1, wherein said at least one seat is provided with flexible hooks adapted to allow the insertion of said LED module and its mechanical locking within said seat.

3. The device according to claim 1, wherein said body accommodates metallic contacts adapted to protrude from said body within said seat, facing toward said seat, in order to provide electrical contact on said LED module.

4. The supporting device according to claim 1, wherein said body has a pair of holes for the insertion of conductors connected to power supply means.

5. The device according to claim 1, wherein said base of said body is adapted to be installed in holes intended for traditional lamp holders that are adapted to be applied to said ceiling fixture.

6. The device according to claim 3, wherein said body is provided with an additional pair of holes that are adapted to allow the execution of tests on said metallic contacts.

7. The device according to claim 1, further comprising clips adapted to be connected to said LED module and to allow the support of said LED module.

8. The device according to claim 1, wherein said base is adapted to mate mechanically and electrically, without the aid of tools, with said ceiling fixture.

9. The device according to claim 1, further comprising a covering element made of transparent plastic material which is adapted to be arranged around said LED module so as to define an LED lamp.

10. The device according to claim 1, wherein said body is provided with a pair of pins that are adapted to allow the wall fixing of said body.
